(19) United States
(12) Patent Application Publication
(10) Pub. No.: US 2022/0316651 A1
(43) Pub. Date: Oct. 6, 2022

(54) REMOVABLE OR ADJUSTABLE COVER FOR GARAGE DOOR SENSOR

(71) Applicant: Rick Hagel, Buna, TX (US)

(72) Inventor: Rick Hagel, Buna, TX (US)

(21) Appl. No.: 17/848,706

(22) Filed: Jun. 24, 2022

Related U.S. Application Data
(63) Continuation-in-part of application No. 17/382,690, filed on Jul. 22, 2021, now Pat. No. 11,396,975.
Application No. 17/382,690 is a continuation-in-part of application No. 16/922,307, filed on Jul. 7, 2020, now Pat. No. 11,125,004.
(60) Provisional application No. 62/871,317, filed on Jul. 8, 2019.

(51) Int. Cl. F16M 13/02; F16M 11/04; E05F 15/43

(52) U.S. Cl. CPC F16M 13/022; F16M 11/048; E05F 15/43; E05Y 2201/11; E05Y 2600/45; E05Y 2900/106

(57) ABSTRACT

A sensor unit includes a garage door sensor with a housing and a sensor. A frame is connected to the garage door sensor and is configured to be secured at one side of an opening for a garage door. A cover is configured to be secured to the garage door sensor in a removable fashion. The cover extends about at least a portion of the housing of garage door sensor in a manner which permits transmission and reception of signals at the sensor when installed.

### CROSS-REFERENCE TO RELATED APPLICATIONS

This application is a continuation-in-part of U.S. application Ser. No. 17/382,690 filed Jul. 22, 2021, which is a continuation-in-part of U.S. application Ser. No. 16/922,307 filed Jul. 7, 2020, now U.S. Pat. No. 11,125,004, which claims the benefit of U.S. provisional patent application No. 62/871,317 filed Jul. 8, 2019, the disclosures of each of which are hereby incorporated by reference as if fully restated.

### TECHNICAL FIELD

Exemplary embodiments relate generally to a removable or adjustable cover for a garage door sensor.

### BACKGROUND AND SUMMARY OF THE INVENTION

Garage door sensors are common fixtures in the modern home and are sometimes required by law. Such sensor systems generally comprise a pair of photo eyes located on opposite sides of an opening to a garage. One or both sensors transmit a signal which is received by the opposing sensor. Interruption of this signal, such as by breaking the line of sight between the sensors, may cause garage door operation to be interrupted or prevented. Generally, interruption of the beam while the garage is being closed causes the garage door to reverse directions and begin opening. Generally speaking, the objective behind such sensor systems is to prevent the garage door from closing on a person or object.

These sensors, particularly where they comprise photo eyes, may be affected by ambient lighting. For example, during sunrise and sunset hours, ambient light may strike one or both of the sensors, causing them to malfunction. It is known to place covers over one or both sensors to limit the ability for ambient light to strike one or both sensors. However, such covers generally require customization and are difficult to make and install. Furthermore, such covers are generally non-adjustable. Further still, these covers sometimes become broken or otherwise in need of repair and replacement. As another example, these covers sometimes gather debris such as leaves, dust, twigs, cobwebs, insects, and the like, which may result in malfunction of the sensors. Therefore, what is needed is a removable or adjustable cover for a garage door sensor.

A removable or adjustable cover for a garage door sensor is provided. The cover may comprise a square or rectangular shape cover which is configured for sliding movement with respect to the sensor. The cover may comprise a slot which permits removal and/or adjustment with respect to the distance the cover extends from a distal end of the sensor. A receiving portion may be provided on a top surface of the sensor and may be configured to receive a fastener. The receiving portion may comprise an aperture, notch, protrusion, indentation, shelf, some combination thereof, or the like. A proximal end of the fastener may be received within the receiving portion, pass through an aperture in a mounting frame, and through the slot. A nut may be secured to a distal end of the fastener protruding from the aperture to secure the cover to the frame. In this way, the sensor may be secured to the frame by a press-fit, mechanical compression, friction, some combination thereof, or the like.

Various types of garage door sensors may be constructed differently and therefore necessitate different cover embodiments. In exemplary embodiments, the removeable cover may comprise a hollow, cylindrical shape. The cover may be configured to fit within a recess between a protrusion formed in a housing of said garage door sensor for a photo eye of the garage door sensor and the photo eye. The cover may comprise a sidewall thickness configured to provide a friction fit between the protrusion and the photo eye to removably secure said cover within a gap defined, at least in part, by an inner surface of said protrusion and an outer surface of said photo eye. The protrusion may comprise a hollow cylindrical shape. The photo eye may comprise a generally cylindrical shape. The garage door sensor may be mounted to a frame configured for selective attachment to a wall, track for a garage door, combinations thereof, or the like.

In other exemplary embodiments, the cover may comprise a hollow cylindrical shape with a rear surface located at a distal end thereof. The rear surface may comprise an aperture configured for placement between a rear surface of said photo eye and/or a rear surface of the protrusion and a front surface of said frame and/or a front surface of the housing for the garage door sensor. In this manner, the cover may be secured frictionally within a gap between the rear surface of the protrusion and/or or a rear surface of the photo eye and a front surface of said frame and/or a front surface of the housing for the garage door sensor.

In still other exemplary embodiments, the cover may comprise a multi-part case. The case may comprise a first portion and a second portion, for example. The first and second portions may be configured for joining about some or all of the garage door sensor. The case may generally conform to the shape of the underlying sensor when joined. The first and second portions may be joined in a removeable or semi-permanent fashion. A portion of the case may protrude outward to extend beyond a housing of the sensor when installed, such as to shield the sensor from ambient light. The protruding portion may be length adjustable. The cover may be configured to accommodate electrical connections for the garage door sensor and/or the mounting frame for the garage door sensor.

Further features and advantages of the systems and methods disclosed herein, as well as the structure and operation of various aspects of the present disclosure, are described in detail below with reference to the accompanying figures.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 is perspective view of an exemplary garage door sensor and cover;

FIG. 2 is a front view of the garage door sensor and cover of FIG. 1;

FIG. 3 is a top view of the garage door sensor and cover of FIG. 1;

FIG. 4 is a top perspective view of the garage door sensor and cover of FIG. 1 in a disassembled state;

FIG. 5 is a side perspective view of the garage door sensor with another exemplary cover;

FIG. 6 is a top view of the garage door sensor and cover of FIG. 5 in a disassembled state;

FIG. 7 is a top view of the garage door sensor with another exemplary cover;

FIG. 8 is a rear view of an exemplary garage door in a closed position from within a garage with an exemplary adjustable sensor unit installed;

FIG. 9 is a front perspective view of another exemplary garage door sensor without a cover;

FIG. 10 is a front perspective view of the exemplary garage door sensor of FIG. 9 with an exemplary cover installed;

FIG. 11 is a front perspective view of the exemplary garage door sensor of FIG. 9 with another exemplary cover installed;

FIG. 12 is a rear perspective view of the exemplary cover of FIG. 11 shown in isolation;

FIG. 13A is a perspective view of another exemplary garage door sensor;

FIG. 13B is a front view of the garage door sensor of FIG. 13A;

FIG. 13C is a top view of the garage door sensor of FIG. 13A;

FIG. 14A is a perspective view of an exemplary cover for the garage door sensor of FIG. 13A-13C;

FIG. 14B is the perspective view of FIG. 14A with exemplary explode lines for a first and second portion of the cover;

FIG. 15A is a perspective view of an exemplary cover for the garage door sensor of FIGS. 13A-13C;

FIG. 15B is the perspective view of FIG. 15A with exemplary explode lines for a first and second portion of the cover; and

FIG. 16 is a perspective view of another exemplary cover for the garage door sensor of FIG. 13A-13C.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

Embodiments of the invention are described herein with reference to illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

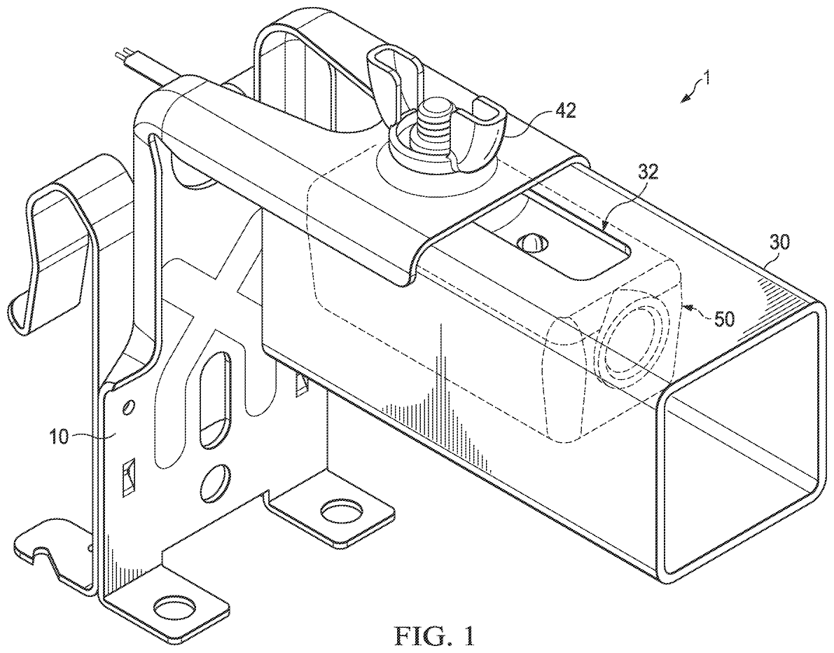

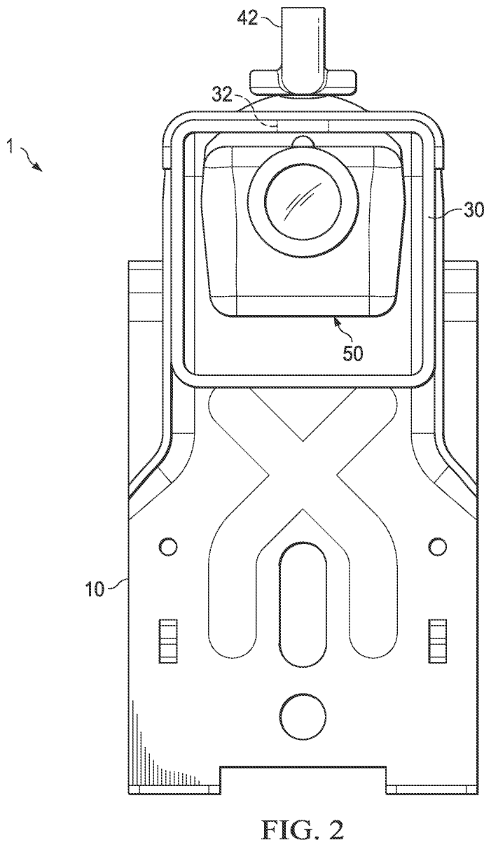

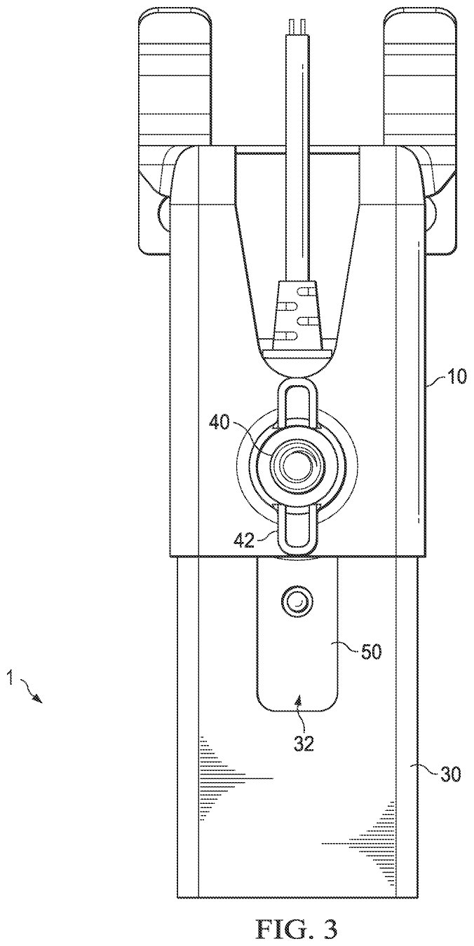

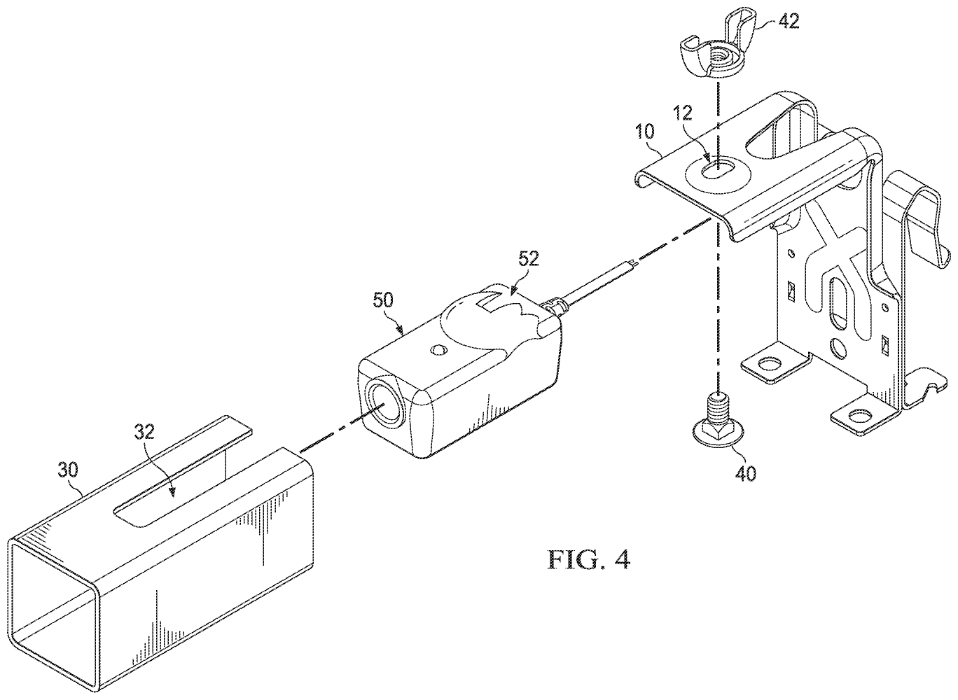

FIG. 1 through FIG. 4 and FIG. 8 illustrate various views of the garage door sensor 50 and cover 30. The garage door sensor 50 may be mounted to a frame 10. At least the garage door sensor 50 and cover 30 may collectively form an adjustable sensor unit 1. The adjustable sensor unit 1 may include the frame 10, though such is not necessarily required. The adjustable sensor unit 1 may include various components of the garage door sensor 50, cover 30, and frame 10. The frame 10 may comprise a first portion 14 configured to secure the sensor 50 a vertical and/or horizontal distance from a floor and/or a wall of the garage. Alternatively, or additionally, the frame 10 may comprise a second portion 18 configured to secure the sensor 50 a vertical and/or horizontal distance from a track 3 or other frame member 13 for the garage door 15 or a wall 11. The first portion 14 may extend substantially perpendicular to the second portion 18. The second portion 18 may extend from a distal end of the first portion 14. The frame 10 may form a substantially “L” shape, though any shape is contemplated.

The frame 10 may comprise a clip 19 for attachment to the track 3 or other component of the garage door assembly 9, though such is not required. Any size, shape, or kind of frame 10 is contemplated. The frame 10 may be configured to secure the sensor 50 in position, preferably aligned with a second sensor 50, a reflector plate 7, or the like. In exemplary embodiments, at least one sensor 50 may be installed on either side of an opening 5 for a garage door 15. In other exemplary embodiments, a single sensor 50 may be positioned on one side of an opening 5 for a garage door 15 and a reflector plate 7 may be located on the opposing side of the opening 5.

Some or all of the cover 30 may be shaped as a hollow cube, cuboid, and/or cylindrical shape, though any size or shape is contemplated. The cover 30 may be comprised of a rigid polymer, though any material is contemplated. In exemplary embodiments, the cover 30 may be the same shape as the sensor 50. The hollow portion of the cover 30 may be configured to fit over some or all of the sensor 50. Sufficient clearance may be provided between the cover 30 and the sensor 50 to permit axial adjustment of the cover 30 relative to the sensor 50.

The cover 30 may be configured for movement relative to the sensor 50. Alternatively, or additionally, the cover 30 may be configured for movement relative to the frame 10. In this way, the distance the cover 30 extends from the sensor 50 may be adjusted. This may permit control of the amount of ambient light allowed to contact the sensor 50, as well as clearance for passing vehicles, some combination thereof, and the like. The cover 30 may comprise a slot 32. The slot 32 may extend along some or all of the cover 30 to facilitate movement of the cover 30. The slot 32 may comprise one or more protrusions or the like configured to selectively and temporarily secure the cover 30 at any one or a number of positions.

The cover 30 may be configured for selective removal such as for replacement, repair, some combination thereof, or the like. In exemplary embodiments, the slot 32 may extend along an upper surface of the cover 30 to an outer edge of the cover 30 so as to facilitate removal of the cover 30 from the sensor 50 and/or the frame 10.

The frame 10 may comprise an aperture 12. In exemplary embodiments, the aperture 12 is located in the second portion 18 of the frame 10, though any location on the frame 10 is contemplated. The aperture 12 may be configured to receive a fastener 40. A receiving portion 52 located in the sensor 50 may be configured to accommodate at least a portion of the fastener 40. The receiving portion 52 may comprise an aperture, notch, protrusion, indentation, shelf, hole, threaded hole, some combination thereof, or the like.

The receiving portion 52 may be configured to receive a first end of the fastener 40. The first end of the fastener 40 may comprise a head portion and a threaded portion, though any type of fastener 40 is contemplated. The fastener 40 may comprise a threaded portion configured to receive a nut 42. The threaded portion may be located at a second end of the fastener 40. In exemplary embodiments, the nut 42 is a wing-nut, though any type of nut is contemplated. One or more washers 44 may be used between the nut 42 and various components such as the frame 10, the sensor 50, and/or the cover 30. The fastener 40 may be sized to be temporarily secured within the receiving portion 52, extend therefrom through the slot 32, through the aperture 12, and extend from the frame 10 sufficient distance to receive the nut 42. Tightening the nut 42 may cause pressure to be exerted between the sensor 50 and the frame 10 such that the cover 30 is trapped therebetween. In this way, the position of the cover 30 may be temporarily fixed relative to the sensor 50 such that the distance the cover 30 extends from the sensor 50 may be adjusted.

The nut 42 may be loosed to permit adjustment and/or removal of the cover 30. In this way, the amount of ambient light permitted to hit the sensor 50 may be adjusted. For example, it may be desirable to adjust the cover 30 based on the time of day, time of year, season, location of the garage, for vehicle clearance, some combination thereof, or the like. In this way, the cover 30 may also be removed for replacement, cleaning, repair, some combination thereof, or the like. In particular, the cover 30 may be removed to clean out debris and the like, which may affect the performance of the sensor 50.

While the fastener 40 and nut 42 are described herein, those of skill in the art will recognize that alternative configurations for securing the cover 30 to the frame 10 are contemplated. For example, without limitation, a protrusion may be used in substitution for the fastener 40 and a clamp may be used in substitution for the nut 42. As another example, without limitation, a protrusion may be used in substitution for the fastener 40 and a pin may be used in substitution for the nut 42.

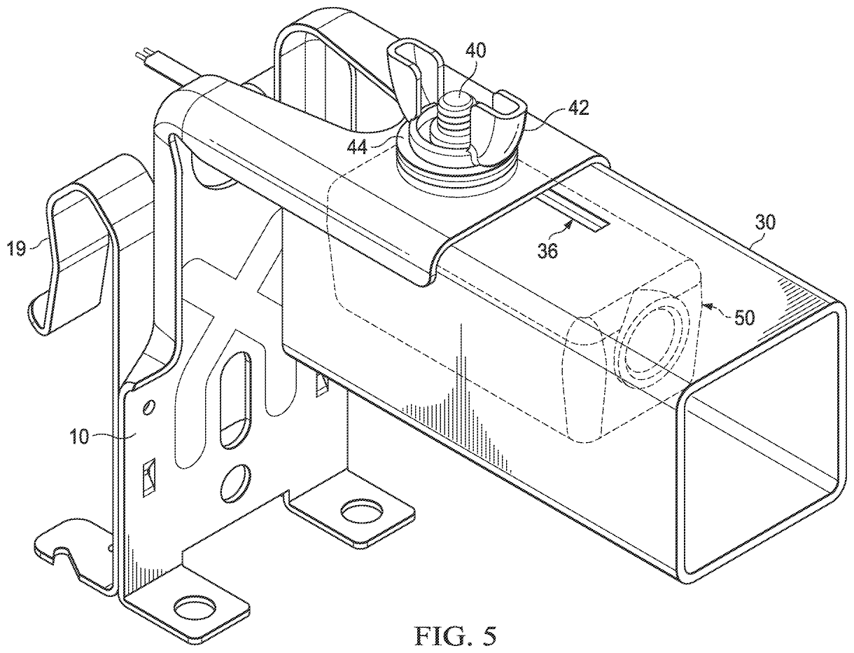

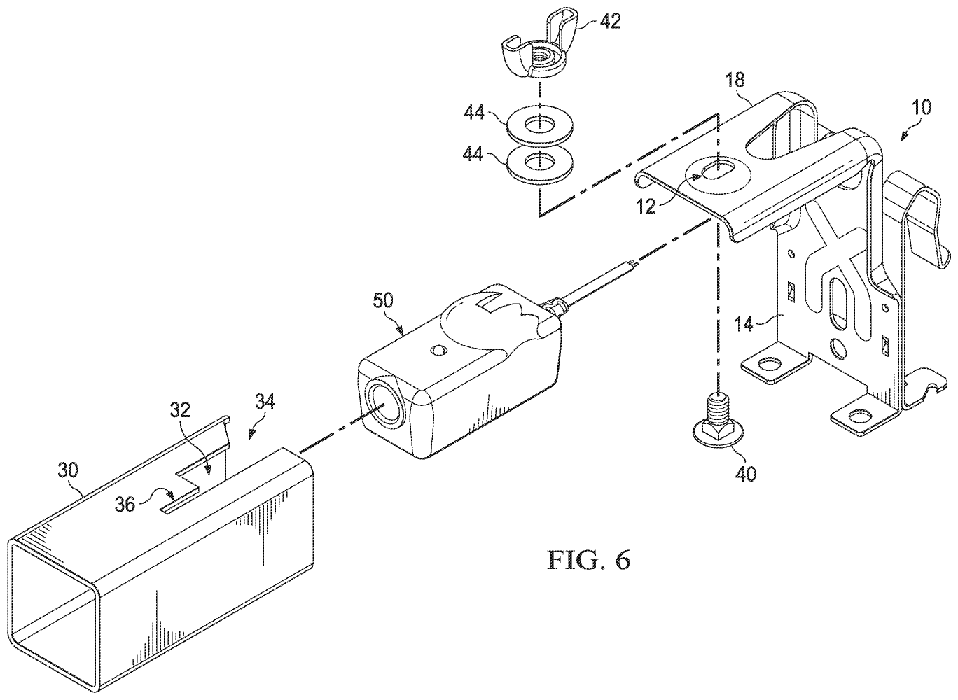

FIG. 5 and FIG. 6 illustrate the garage door sensor 50 with another exemplary cover 30. The frame 10, sensor 50, fastener 40, and nut 42, and various components and features thereof, may be the same or similar to those shown and described with respect to FIGS. 1-4. The cover 30 may comprise the slot 32. The slot 32 may comprise a rear notch 34. The rear notch 34 may be located on a proximal end of the slot 32. The rear notch 34 may be located at an outer edge of the cover 30. The rear notch 34 may comprise an enlarged area which may facilitate ease of removal of the cover 30. The slot 32 may further comprise a front notch 36. The front notch 36 may extend from a distal end of the slot 32. The front notch 36 may comprise a narrowed area which may facilitate additional flexibility in the cover 30 to permit ease of fitting over the sensor 50. The front notch 36 may be sufficiently narrow to prevent the fastener 40 from passing within or through the front notch 36. Although two standard washers 44 are shown, it is contemplated that any type, size, number, of kind of washer 44 such as but not limited to, lock washer, split washers, grommets, and the like are contemplated in addition to, or instead of, the illustrated washers 44.

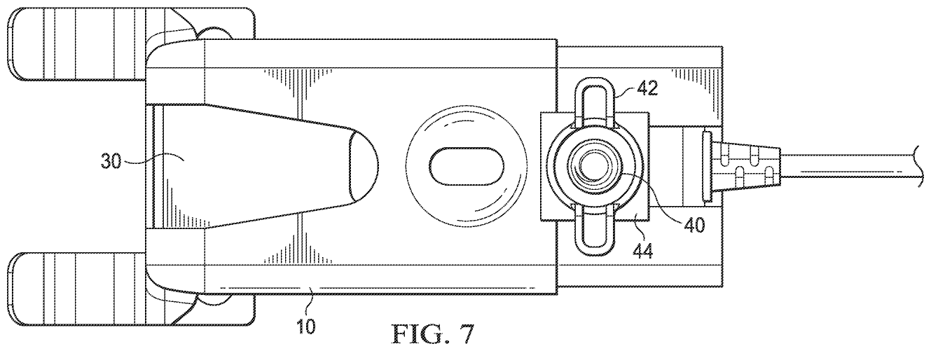

FIG. 7 is a top view of the garage door sensor 50 and another exemplar cover 30. One or more of the washers 44 may be shaped as a square, rectangular, or other shape plate. Such a square, rectangular, or other shape plate may be used in place of, or in addition to, traditional, round shaped washers 44. The plate 44 may comprise an aperture configured to accommodate the fastener 40 but not permit the nut 42 to pass therethrough. It is also contemplated that the sensor 50 may be oriented such that the photo-eye portion faces towards the first portion 14 of the frame 10.

Any type, size, shape, or other configuration of the frame 10 and/or the sensor 50 are contemplated. Each sensor 50 may comprise one or more photo-eyes, through other types of sensors 50 such as, but not limited to, ultrasonic, laser, cameras, some combination thereof, or the like are contemplated.

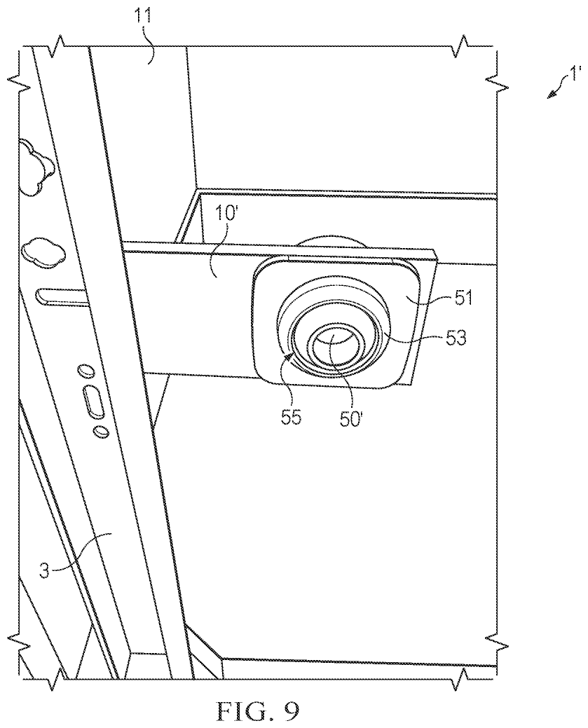

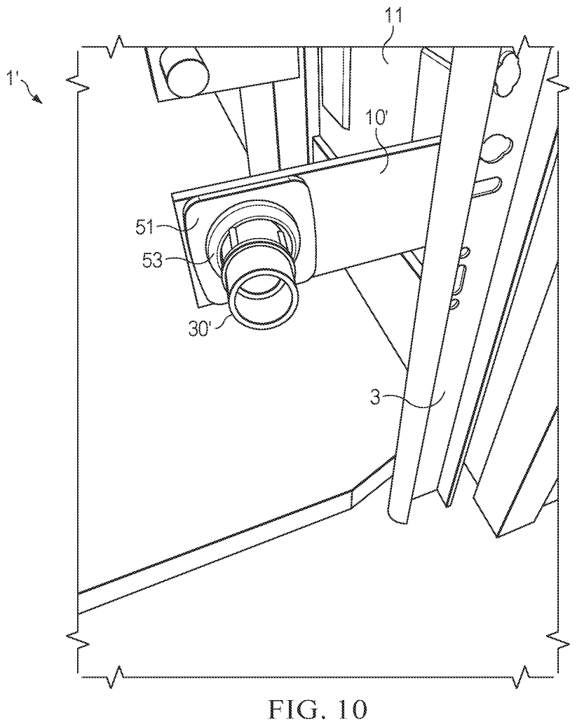

FIG. 9 and FIG. 10 illustrate another exemplary sensor unit 1′. The same or similar components may be numbered similarly but with the addition of a prime (e.g., 10 to 10′). The sensor unit 1′ may comprise a same or different type of garage door sensor 50′. The garage door sensor 50′ may be mounted to a frame 10′. The frame 10′ may be configured for securement to a wall 11, a track 3 for a garage door 15, other frame member of the garage door assembly 9, combinations thereof, or the like. The garage door sensor 50′ may be attached to the frame 10′, such as by extending a portion of the garage door sensor 50′ through a portion of the frame 10′.

The garage door sensor 50′ may comprise a housing 51 for a sensor 50′, such as a photo eye for example without limitation. The housing 51 may comprise a protrusion 53. The protrusion 53 may comprise a hollow cylindrical shape, though any size or shape protrusion 53, or multiple protrusions provided in a pattern or generally forming a shape, may be provided. The sensor 50′ may extend a distance from the housing 51.

The sensor unit 1′ may comprise a removable cover 30′. The cover 30′ may comprise a hollow, cylindrical shape. However, other size or shape covers 30′ may be utilized. The cover 30′ may be configured to fit within a gap 55 between the protrusion 53 and the sensor 50′. The cover 30′ may comprise a sidewall thickness configured to provide a friction fit between the protrusion 53 and the sensor 50′ to removably secure said cover 30′ therein. The sensor 50′ may comprise a generally cylindrical shape and may be located in a same or different housing 51, though such is not required and the senor 50′ may comprise any shape, type, or kind of sensor.

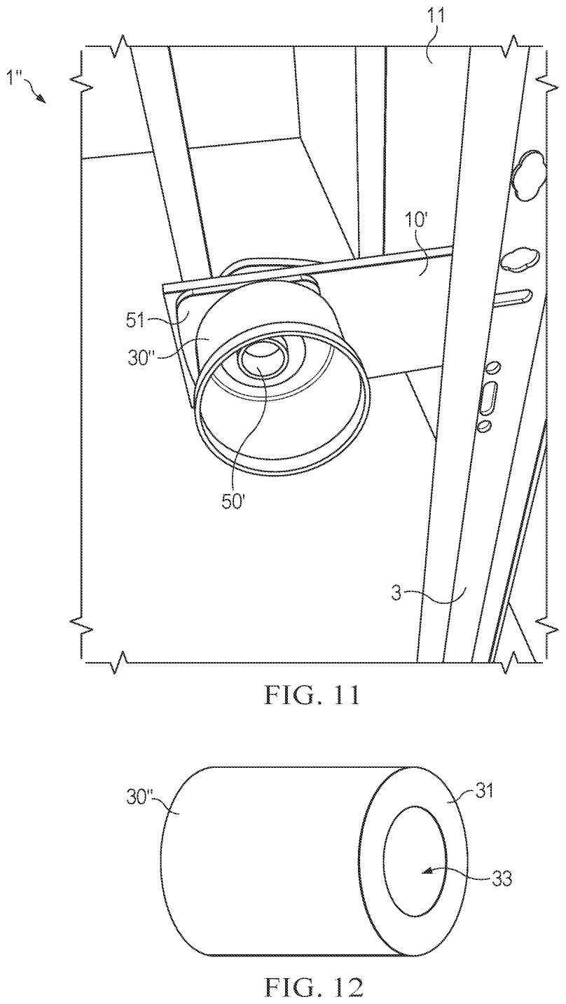

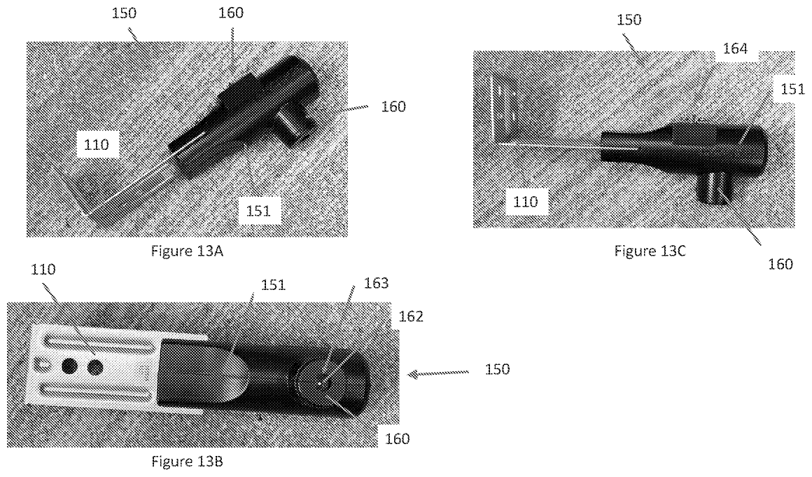

FIG. 11 and FIG. 12 illustrates another exemplary sensor unit 1″. The same or similar components may be numbered similarly but with the addition of one or two primes (e.g., 10 to 10′ to 10″). The cover 30″ may comprise a hollow cylindrical shape with a rear surface 31 located at a distal end thereof. However, other size or shape covers 30″ may be utilized. The rear surface 31 may comprise an aperture 33 configured for placement between a surface of said sensor 50′ and/or a front surface of said frame 10′ and a rear surface of the protrusion 53. In this manner, the cover 30″ may be secured frictionally within a gap between the rear surface of the protrusion 53 and a front surface of said frame 10′ or a surface of said sensor 50′.

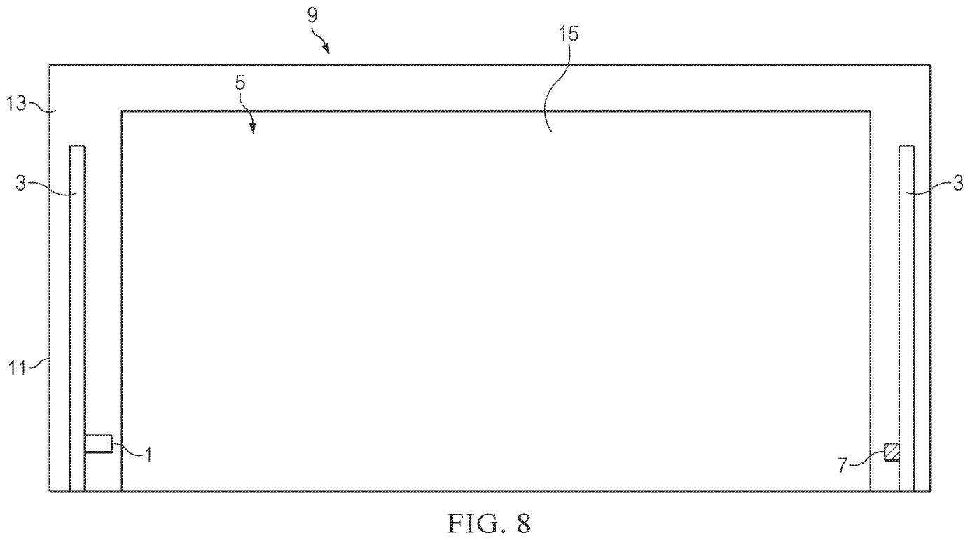

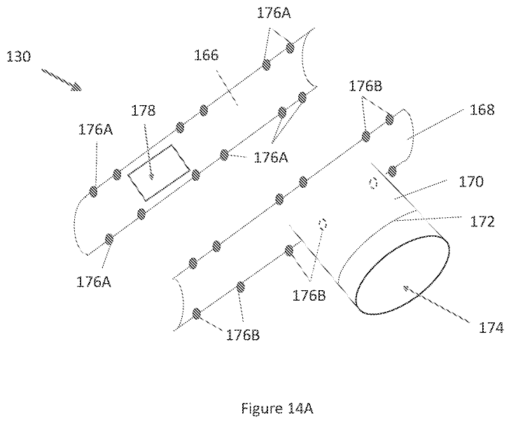

FIG. 13A through FIG. 13C illustrate another exemplary sensor unit 101. The same or similar components may be numbered similarly but increased by 100 (e.g., 10, 10′, or 10″ to 110). The sensor 150 may comprise, or by configured for attachment to, a frame 110. The frame 110 may be configured for attachment to one or more of the tracks 3 or the walls as adjacent to one or more of the garage doors 15 or the openings 5. By way of non-limiting example, the sensor 150 may be installed as shown and/or described with regard to FIG. 8.

The sensor 150 may comprise a housing 151. The housing 151 may include a protruding portion 160. A photo eye, reflector, and/or other sensor 162 may be at least partially housed within protruding portion 160. The sensor 162 may be configured to projected signals out of, or receive signals through, one or more apertures 163 provided at a distal end of the protruding portion 160. The sensor 150 may comprise an interface portion 164. The interface portion 164 may comprise one or more electrical contacts, such as but not limited to, for providing power, signaling, or other functionality to the sensor 150. The interface portion 164 may comprise one or more fasteners, such as screw heads, for attaching electrical wires, by way of non-limiting example. The sensor 150 may comprise, for example without limitation, the SAFE-T-BEAM® available from Overhead Door Corporation of Lewisville, Tex. (https://www.overheaddoor.com/garage-door-opener-safety-beams), such as model number OSTB-BX and/or parts 37221 R and/or 37221L. By way of non-limiting example, other sensors 150 with protruding portions 160 and/or generally having a “T” shape may be utilized. Any type or kind of sensor 150 may be utilized.

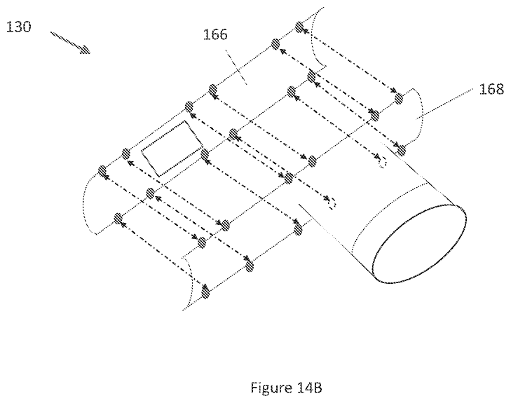

FIG. 14A and FIG. 14B illustrate an exemplary cover 130, such as for use with the sensor 150. The cover 130 may comprise multiple portions, such as a first portion 166 and a second portion 168. The cover 130 may generally comprise a “T” shape. The first portion 166 may be generally curved or otherwise shaped to match and/or conform to a shape of the housing 151 of the sensor 150. The second portion 168 may be generally curved or otherwise shaped to match and/or conform to a shape of the housing 151 of the sensor 150. Any size, shape, or number of portions 166, 168 may be utilized, such as to fit to any size, shape, or type of sensor 150.

The second portion 168 may comprise a protruding portion 170. The protruding portion 170 may be hollow and/or shaped to accommodate the protruding portion 160 of the sensor 150. The protruding portion 170 of said cover 130 may be configured to extend beyond a distal end of the protruding portion 160 of the sensor 150 when installed. Any size or shape protruding portion 170 may be utilized, such as to fit to any size, shape, or type of sensor 150. The protruding portion 170 may be integrally formed with the second portion 168, though such is not required.

The protruding portion 170 may be removable from the cover 130. Alternatively, or additionally, the protruding portion 170 may be length and/or otherwise position adjustable. For example, without limitation, the protruding portion 170 may comprise multiple parts configured for telescoping, sliding, folding, compression, and/or expansion movement, and/or utilizes clamps, threaded surfaces, interlocking configurations, snap fit, friction fit, combinations thereof, or the like to permit relative length adjustment and/or removability of the multiple portions of the protruding portion 170. Alternatively, or additionally, the protruding portion 170 may comprise multiple parts. This may provide adjustability to a length the protruding portion 170 extends from a remainder of the second portion 168 (a protruding distance), such as relative to the sensor 162. This may permit adjustment for shielding the sensor 162 from ambient light (e.g., sunlight) or debris. This may, alternatively or additionally, permit removal of at least part of the protruding portion 170. In yet other exemplary embodiments, the entire protruding portion 170 may be adjustable and/or removable, such as in the manner described. In other exemplary embodiments, without limitation, the protruding portion 170 may be fixed, such as to the second portion 168.

The first portion 166 may comprise one or more apertures 178. The aperture(s) 178 may be configured to accommodate certain portions of the sensor 150, including but not necessarily limited to, some or all of the interface portion 164. The aperture(s) 178 may be configured to permit access to the interface portion 164, such as for connecting wiring or other electrical components. The aperture(s) 178 may be integrally formed and/or removable (e.g., punch out). Any number, type, and/or arrangement of aperture(s) 178 may be provided.

The first and second portions 166, 168 may be configured for selective connection to one another. In this manner, the sensor 150 may be at least partially enclosed. In exemplary embodiments, without limitation, the first and/or section portions 166, 168 may each comprise one or more attachment points 176. The attachment points 176 may comprise holes, tabs, protrusions, notches, grooves, combinations thereof, or the like, by way of non-limiting example. For example, without limitation, attachment points 176 may comprise holes. String, wire, rope, shock cords, cable ties (e.g., zip tie, wire tie, hose tie, steggel tie, mouse belt, rat belt, wire wrap, zap strap, tie wraps), combinations thereof, or the like, may be passed through the attachment points 176 to secure the first and second portions 166, 168 to one another, such as about some or all of the housing 151 for the sensor 150. Alternatively, or additionally, clamps (e.g., hose clamps) may be provided to extend about and secure both the first and second portions 166, 168 to one another and/or the sensor 150. Alternatively, or additionally, mating protrusions and/or holes may be utilized which are configured to mate with one another.

Alternatively, or additionally, one or more adhesives, tape (e.g., double sided), combinations thereof, or the like, may be used to join the first and second portions 166, 168 to one another. The adhesive(s) may comprise glue, epoxy, combinations thereof, or the like. Alternatively, or additionally, the first and second portions 166, 168 may be joined by welding or the like.

A first set of attachment points 176A may be associated with the first portion 166, and a second set of attachment points 176B may be associated with the second portion 168. In exemplary embodiments, without limitation, a number of the first set of attachment points 176A may be spaced apart along an upper edge of the first portion 166, and a number of the first set of attachment points 176A may be spaced apart along a lower edge of the first portion 166. A number of the second set of attachment points 1768 may be spaced apart along an upper edge of the second portion 168, and a number of the second set of attachment points 1768 may be spaced apart along a lower edge of the second portion 168. The first and second set of attachment points 176A, 1768 may be configured to mate with one another, such as but not limited to in a readily removable and reattach-able fashion, semi-nonremovable, and/or permanent fashion. Any number, arrangement, type, or the like of the attachment points 176 may be utilized.

In other exemplary embodiments, without limitation, some or all of the attachment points 176 may be provided at the housing 151 for the sensor 150. In this fashion, attachment points 176 on the cover 130 may be configured for securement to the attachment points 176 on the housing 151 for the sensor 150.

The first and second portions 166, 168 may fit together in a seamless, or substantially seamless, fashion. For example, the first and second portion 166, 168 may be sized to contact one another when installed about the sensor 150. Alternatively, a gap may extend between the first and second portions 166, 168 when installed which may be bridged, in part, by the attachment points 176 or associated components (e.g., rope, wire, cable ties, etc.).

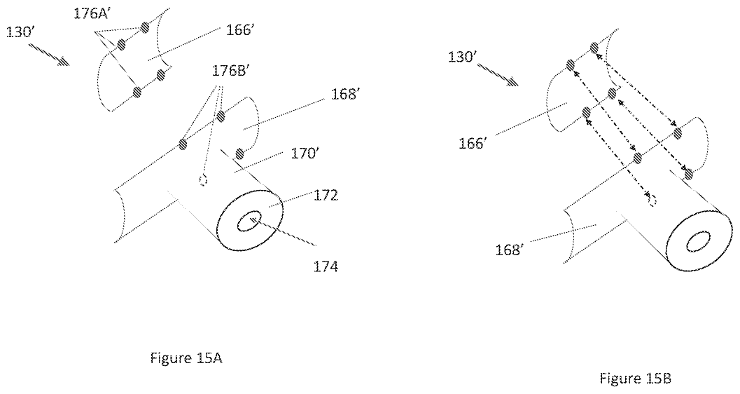

FIG. 15A and FIG. 15B illustrate another exemplary embodiment of the cover 130′. The same or similar components may be numbered similarly but with the addition of a prime (e.g., 130 to 130′). The first portion 166′ may be smaller than the second portion 168′, though such is not required. The first portion 166′ may be sized to avoid the interface portion 164, for example. The first portion 166′ may have a length which is smaller than a length of the second portion 168′, though the two components may be similarly size and/or the second portion 168′ may be smaller in length than the first portion 166′ in other exemplary embodiments, without limitation.

The protruding portion 170′ may comprise a front surface 172. The front surface 172 may comprise one or more apertures 174. The aperture(s) 174 may be sized to substantially match a size and/or shape of the aperture 163 in the housing 151 for the sensor 162, though such is not required. The aperture(s) 174 may be larger or smaller than the sensor(s) 162 in other exemplary embodiments. The front surface 172 may assist with preventing debris entry and/or limit ambient light from striking the sensor 162.

The protruding portion 170′ may be distance adjustable and/or removable, though such is not required.

The first and second portions 166′, 168′ may comprise a first and second set of attachment points 176A′, 176B′ configured to connect the first and second portions 166′, 168′, such as in a readily removable and reattach-able fashion, semi-nonremovable, and/or permanent fashion. The attachment points 176A′, 176B′ may alternatively or additionally be located at the sensor 150.

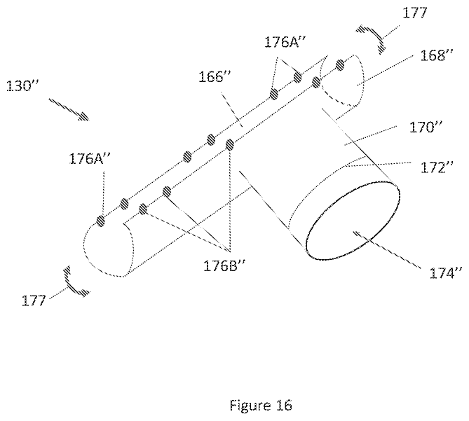

FIG. 16 illustrates another exemplary embodiment of the cover 130″. The same or similar components may be numbered similarly but with the addition of two primes (e.g., 130 to 130′ to 130″). The first portion 166″ and the second portion 168″ may be moveably connected to one another. For example, without limitation, the first and second portions 166″ and 168″ may be permanently connected along a lower edge. The connection may be integrally formed and/or may permit the first and second portions 166″ and 168″ to move to selectively enclose the sensors 150, such as in a hinging and/or clam-shell type arrangement, such as generally indicated by arrow 177. Attachment points 176A″ and 176B″ may be utilized to semi-permanently or temporarily secure the first and second portions 166″ and 168″ to one another, such as along an upper edge thereof. Such connection may be made by way of snap-fit, by way of non-limiting example. Alternatively, other components, such as but not limited to, cable, wire, string, clamps, combinations thereof, or the like may be placed over the portions 166″ and 168″ to secure them to one another and/or the sensor 150.

Alternatively, or additionally, one or more adhesives, tape, combinations thereof, or the like, may be used to join the first and second portions 166″, 168″ to one another. For example, without limitation, adhesive may be deposited along a free edge of one or both of the first and second portions 166″, 168″ before the first and second portions 166″, 168″ are moved into contact and the adhesive is permitted to cure. Such deposits may be made by way of a single bead, multiple beads, or the like. The adhesive(s) may comprise glue, epoxy, combinations thereof, or the like. As another example, without limitation, double sided tape may be placed along one or both free edges of the first and second portions 166″, 168″ before the first and second portions 166″, 168″ are moved into contact. The tape may be deposited in a single or multiple locations in a single or multiple pieces. Alternatively, or additionally, the first and second portions 166″, 168″ may be joined by welding or the like.

Alternatively, permanent connection made be made along an upper edge of the first and second portions 166″ and 168″ and temporary or semi-permanent connection may be made along the lower edge of the first and second portions 166″ and 168″. Any number of portions 166″ and 168″ may be utilized and connected in a moveable manner to selectively enclose some or all of the sensor 150. Connection of such portions 166″ and 168″ may be made along any edges.

In any of the embodiments shown and/or described herein, the cover 30, 30′, 30″, 130, 130′, 130″ may be removed from the associated garage door sensor 50, 50′, 50″, 150 for cleaning of the garage door sensor 50, 50′, 50″, 150. The cover 30, 30′, 30″, 130, 130′, 130″ may be subsequently reinstalled. Where not needed, or no longer needed, the cover 30, 30′, 30″, 130, 130′, 130″ may be permanently or temporarily removed, such as during evening hours, seasonally, depending on location or orientation of placement, direction the garage faces, combinations thereof, or the like. This may also permit the cover 30, 30′, 30″, 130, 130′, 130″ to be periodically, such as upon breaking of the cover 30, 30′, 30″, 130, 130′, 130″ or otherwise desired by a user.

Any embodiment of the present invention may include any of the features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A sensor unit comprising:
a garage door sensor comprising a housing and a sensor;
a frame connected to said garage door sensor and configured to be secured at one side of an opening for a garage door; and
a cover configured for removable installation about at least a portion of said housing, wherein said cover is configured to, when installed, block at least some ambient light from striking the sensor while permitting transmission and reception of signals at the sensor.

2. The sensor unit of claim 1 wherein:
said cover comprises multiple, separate portions which are configured to be joined together about at least a portion of the housing.

3. The sensor unit of claim 2 wherein:
said housing of said garage door sensor comprises a protruding portion configured to accommodate at least part of said sensor;
said multiple portions comprise a first portion conforming to a rear surface of said housing and a second portion conforming to a front surface of said housing;
said second portion comprises a protruding portion and is configured to accommodate said protruding portion of said housing of said garage door sensor; and
said protruding portion of said second portion of said cover extends beyond a distal end of said protruding portion of said sensor when said cover is installed.

4. The sensor unit of claim 3 further comprising:
a first set of attachment points located at said first portion; and
a second set of attachment points located at said second portion, wherein said first and second set of attachment points are configured to mate with one another.

5. The sensor unit of claim 4 wherein:
a first number of said first set of attachment points are spaced apart along an upper edge of the first portion;
a second number of said first set of attachment points are spaced apart along a lower edge of the first portion;
a first number of said second set of attachment points are spaced apart along an upper edge of the second portion; and
a second number of said second set of attachment points are spaced apart along a lower edge of the second portion.

6. The sensor unit of claim 4 further comprising:
cable ties, wherein the first set of attachment points comprise holes, each configured to accommodate one of said cable ties, and wherein the second set of attachment points comprise holes, each configured to accommodate one of said cable ties.

7. The sensor unit of claim 4 wherein:
the first set of attachment points comprise protrusions; and
the second set of attachment points comprise holes, each configured to accommodate one of said protrusions in a snap-fit fashion.

8. The sensor unit of claim 3 wherein:
said first portion comprises an aperture sized to accommodate an electrical interface at said housing of said garage door sensor; and
said first portion defines a length matching a length of said second portion.

9. The sensor unit of claim 3 wherein:
said first portion defines a length shorter than a length of said second portion such that an electrical interface at said housing of said garage door sensor is uncovered when said cover is installed.

10. The sensor unit of claim 3 wherein:
said protruding portion of said cover is configured for adjustable movement relative to said protruding portion of said garage door sensor.

11. The sensor unit of claim 3 wherein:
said first portion is permanently attached to said second portion along a lower edge or an upper edge thereof in a manner which permits hinging movement of the first and second portions relative to one another to selectively enclose at least part of the housing for the garage door sensor.

12. The sensor unit of claim 1 wherein:
said sensor comprises a photo eye.

13. The sensor unit of claim 1 further comprising:
a slot in said cover configured to provide adjustable positioning of said cover relative to said sensor;
a threaded fastener configured to be secured to said garage door sensor, extended through said slot, and through an aperture in said frame; and
a nut configured for securement to a portion of said threaded fastener extending through said frame, wherein tightening of said nut is configured to temporarily secure a position of said cover relative to said sensor.

14. The sensor unit of claim 1 further comprising:
a gap extending between said housing and said sensor; and
a protrusion at said cover configured for friction fit within said gap.

15. A method of removably covering a garage door sensor comprising the steps of:
attaching a frame of the garage door sensor to one side of an opening for a garage door; and
attaching a cover to a housing of said garage door sensor in a removable fashion such that said a portion of said cover extends beyond a forward portion of a photo eye of said garage door sensor, wherein said cover permits transmission and reception of signals at the photo eye.

16. The method of claim 15 further comprising the steps of:
removing said cover from said housing;
cleaning or repairing said photo eye of said garage door sensor; and
reattaching said cover to said housing.

17. The method of claim 15 wherein:
said housing of said garage door sensor comprises a protruding portion configured to accommodate at least part of said photo eye;
said cover comprise a first portion conforming to a rear surface of said housing and comprising a first set of attachment points;
said cover comprises a second portion conforming to a front surface of said housing and comprising a second set of attachment points;
said second portion comprises a protruding portion configured to accommodate said protruding portion of said housing of said garage door sensor;
said protruding portion of said second portion of said cover extends beyond a distal end of said protruding portion of said photo eye when installed; and
said first and second set of attachment points are configured to mate with one another.

18. The method of claim 17 further comprising the steps of:
adjusting a length of said protruding portion of said second portion of said cover by telescoping movement.

19. The method of claim 17 further comprising the steps of:
snap fitting the first portion of said cover to said second portion of said cover by way of said attachment points.

20. A sensor unit comprising:
a garage door sensor comprising a photo eye and a housing comprises a protruding portion configured to accommodate the photo eye;
a frame configured to be secured at one side of an opening for a garage door, wherein said garage door sensor is connected to said frame; and
a cover comprising:
a first portion conforming to a rear surface of said housing;
a second portion conforming to a front surface of said housing and comprising a protruding portion configured to accommodate said protruding portion of said housing;
a first number of attachment points spaced apart along an upper edge of the first portion;
a second number of attachment points spaced apart along a lower edge of the first portion;
a third number of attachment points spaced apart along an upper edge of the second portion, wherein said first number of attachment points are configured to mate with said third number of attachment points; and
a fourth number of attachment points spaced apart along a lower edge of the second portion, wherein said second number of attachment points are configured to mate with said fourth number of attachment points;
wherein said cover is configured to enclose at least a portion of said housing when installed, and said protruding portion of said second portion is configured to extend beyond a distal end of said protruding portion of said photo eye when installed to block at least some ambient light and debris from contacting said photo eye.
